(19) United States
(12) Patent Application Publication
(10) Pub. No.: US 2014/0158355 A1
(43) Pub. Date: Jun. 12, 2014

(54) CROSSLINKED SYNTHETIC POLYMER GEL SYSTEMS FOR HYDRAULIC FRACTURING

(71) Applicant: Soane Energy, LLC, Cambridge, MA (US)

(72) Inventors: Philip Wuthrich, Lowell, MA (US); Robert P. Mahoney, Newbury, MA (US); David S. Soane, Chestnut Hill, MA (US); Rosa Casado Portilla, Peabody, MA (US)

(21) Appl. No.: 13/915,065

(22) Filed: Jun. 11, 2013

Related U.S. Application Data
(60) Provisional application No. 61/658,728, filed on Jun. 12, 2012.
(60) Provisional application No. 61/777,564, filed on Mar. 12, 2013.

(51) Int. Cl. C09K 8/588; E21B 33/138; E21B 43/26; E21B 43/16

(52) U.S. Cl. CPC C09K 8/588; E21B 43/16; E21B 33/138; E21B 43/26
USPC 166/294; 507/219; 166/305.1

(57) ABSTRACT

The invention is directed to polymer-enhanced proppant transport fluids, comprising a suspension fluid comprising a crosslinked synthetic polymer gel formulation, and a plurality of proppant particles. The invention also encompasses methods for improving production from an oil or gas well, methods of water blocking or water shutoff in an oil or gas well, methods of enhancing oil recovery from an oil source, methods of treating a petroleum-containing formation to reduce sand production, and methods of displacing fluid from a wellbore by viscous plug flow.

### RELATED APPLICATIONS

This application claims the benefit of U.S. Provisional Application Ser. No. 61/658,728 filed Jun. 12, 2012 and U.S. Provisional Application Ser. No. 61/777,564 filed Mar. 12, 2013. The entire contents of the above-referenced applications are incorporated by reference herein.

### FIELD OF APPLICATION

This application relates generally to systems and methods for recovery of hydrocarbons from subterranean formations.

### BACKGROUND

In the process of acquiring oil and/or gas from a well, it is often necessary to stimulate the flow of hydrocarbons via hydraulic fracturing. The term “fracturing” refers to the method of pumping a fluid into a well until the pressure increases to a level which is sufficient to fracture the subterranean geological formation containing the materials (such as hydrocarbons) entrapped therein. The pressure increase induced by fracturing results in cracks and breaks in the formation that disrupt it sufficiently to allow, for example, a hydrocarbon product to be carried to the well bore at a significantly higher rate than would be available without fracturing. Unless the pressure is maintained, however, the newly formed openings close. In order to maintain the channels opened by fracturing, a propping agent or proppant is injected along with the hydraulic fluid to create the support needed to preserve the newly formed openings. During the fracturing process, the proppants are delivered into the channels in the formation as a slurry; upon release of the hydraulic pressure, the proppants form a pack or a prop that serves to hold open the fractures.

In order to place the proppants inside the fracture, these particles are suspended in a fluid that is then pumped to its subterranean destination. This fluid typically has a high viscosity, so that the particles remain suspended and do not settle. The viscosity of the fluid can be managed by addition of synthetic or natural-based polymers. There are three common types of polymer-enhanced fluid systems generally used to suspend and transport proppants during hydraulic fracturing operations: slickwater, linear gel, and crosslinked gel.

In slickwater systems, an anionic or cationic polyacrylamide is typically added as a friction reducer additive, allowing maximum fluid flow with a minimum of pumping energy. Since the pumping energy requirements of hydraulic fracturing are high, on the order of 10,000 to 100,000 horsepower, a friction reducer is added to slickwater fluids to enable high pumping rates while avoiding the need for even higher pumping energy. Slickwater polymer solutions typically contain 0.5 to 2.0 gallons of friction reducer polymer per 1000 gallons of slickwater fluid, and the solutions have low viscosity, generally on the order of 3 to 15 cps. At this low viscosity, suspended proppant particles can readily settle out of suspension as soon as turbulent flow is stopped. For this reason, slickwater fluids are used in the fracturing stages that have either no proppant, proppant with small particle size, or low proppant loadings.

The second type of polymer-enhanced fluid system is known as a linear gel system. Linear gel systems typically contain carbohydrate polymers such as guar, hydroxyethylcellulose, hydroxyethyl guar, hydroxypropyl guar, and hydroxypropylcellulose. These linear gel polymers are commonly added at a use rate of 10 to 50 pounds of polymer per 1000 gallons of linear gel fluid. These concentrations of linear gel polymer result in a fluid with improved proppant suspending characteristics vs. the slickwater fluid. The linear gel fluids are used to transport proppants, at loading levels of about 0.1 to 1 pound of proppant per gallon of fluid. Above this proppant loading level, a more viscous solution is typically required to make a stable suspension.

Crosslinked gel is the most viscous type of polymer-enhanced fluid used for transporting of proppant. In crosslinked gel systems, the linear gel fluid as described above, for example, a fluid based on guar or modified guar, is crosslinked with added reagents such as borate, zirconate, and titanate in the presence of alkali. The most common version of crosslinked gel is known in the art as guar-borate gel. Upon crosslinking of the linear gel fluid into a crosslinked gel fluid, the viscosity becomes much higher and proppants can be effectively suspended. The linear gel and crosslinked gel fluids have certain advantages, but they require a high dose rate of an expensive biopolymer such as guar. The commercial availability of guar as a raw material is dependent on the productivity of the guar bean crop in India. In recent years, demand for guar has outpaced the supply and prices have been highly volatile. Guar-borate gel systems are also sensitive to the quality of the water used to dissolve the guar. For example, makeup water that contains boron levels above 2 ppm can inhibit the hydration of the guar polymer, and then the boron causes unplanned or undesirable crosslinking of the guar once hydrated. In mild cases, such as boron levels of 5 to 20 ppm, this problem might be manageable by pH control and by custom formulation and testing of the fracturing fluid. In more severe cases, such as boron levels of 20 to 200 ppm, or higher, the makeup water requires pretreatment before it can be used to make up a guar borate gel fluid. The requisite pretreatment of the water is an expensive and undesirable option, as the makeup of guar fluid is commonly done at high flowrates, for example 20 to 80 barrels per minute (or 840 to 3360 gallons per minute) and the treatment equipment needed would be extensive.

While there are known methods in the art for addressing the limitations of crosslinked gel systems, certain problems remain. There is thus a need in the art for improved crosslinked gel systems that provide sufficient suspending power to transport proppant and maximize well production efficiency. It is further desirable that such improved gel systems be cost-effective and commercially available in bulk quantities. It is further desirable that such improved gel systems comprise synthetic polymers rather than natural polymers, so they can be manufactured in scalable quantities without limitations from agricultural crop production. It is further desirable that an improved gel system can hydrate or dissolve, and crosslink or form a network gel, in makeup water that contains contaminants such as boron. Finally, a gel system that is more shear thinning than guar borate gel is desirable, since it can require less pumping energy to pump the fluid into a well at high injection rate.

### SUMMARY

Disclosed herein, in embodiments, are polymer-enhanced proppant transport fluids, comprising a suspension fluid comprising a crosslinked synthetic polymer gel formulation, and a plurality of proppant particles. In embodiments, the crosslinked synthetic polymer gel formulation comprises at least one synthetic base polymer, and a crosslinking agent, wherein the crosslinking agent comprises a dialdehyde or a dual crosslinker system. In embodiments, the dual crosslinker system comprising a dialdehyde and an organometallic reagent. In embodiments, the crosslinked synthetic polymer gel formulation comprises a second base polymer. In embodiments, the second base polymer is a synthetic base polymer. In embodiments, the at least one synthetic base polymer and the second base polymer are crosslinked, and the crosslinking is performed by a crosslinking agent. In embodiments, the crosslinked synthetic polymer gel formulation further comprises a hydrophobically associating base polymer with a tunable surfactant. In embodiments, the crosslinked polymer gel formulation further comprises a superabsorbent polymer or a water soluble polymer.

Disclosed herein are also methods for improving production from an oil or gas well, comprising providing a formulation comprising a crosslinked synthetic polymer gel formulation, and delivering the formulation into the oil or gas well, whereby the formulation improves production from the well. Also disclosed herein are methods of water blocking or water shutoff in an oil or gas well, comprising providing a formulation comprising a crosslinked synthetic polymer gel formulation, and delivering the formulation into the oil or gas well, whereby the formulation provides water blocking or water shutoff in the well. Also disclosed herein are methods of enhancing oil recovery from an oil source, comprising providing a formulation comprising a crosslinked synthetic polymer gel formulation, and delivering the formulation into the oil source, whereby the formulation enhances oil recover from the oil source. Further disclosed herein are methods of treating a petroleum-containing formation to reduce sand production, comprising providing a formulation comprising a crosslinked synthetic polymer gel formulation, and delivering the formulation into the petroleum-containing formation, whereby the formulation reduces sand production in the formation. Also disclosed herein are methods of displacing fluid from a wellbore by viscous plug flow, comprising providing a formulation comprising a crosslinked synthetic polymer gel formulation, and delivering the formulation into wellbore, whereby the formulation forms a viscous plug in the wellbore, thereby displacing fluid therefrom.

### BRIEF DESCRIPTION OF THE FIGURES

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a graph plotting viscosity and temperature as a function of time.

FIG. 2 shows a graph plotting viscosity and temperature as a function of time.

### DETAILED DESCRIPTION

Disclosed herein are formulations comprising crosslinked synthetic polymer gel fluids, and methods for forming and using such fluids in oil field applications, for example, as a suspension fluid for proppants. When used as a proppant suspension fluid, such formulations can suspend and transport proppants more stably, resisting sedimentation, separation, and screenout before the proppant can reach the intended target destination in the fracture. Further benefits of the crosslinked gel fluids as disclosed herein include lower tendency to erode equipment, lower pumping energy requirements, reduced sensitivity to makeup water quality such as boron content, and a stable supply chain that does not rely on agricultural production.

In embodiments, crosslinked synthetic polymer gel systems in accordance with these systems and methods comprise synthetic base polymers that can be crosslinked as described below, including: (1) crosslinking the synthetic base polymers with dialdehydes or dual crosslinkers, one of which is a dialdehyde; (2) crosslinking polymer pairs ionically, optionally with a dialdehyde crosslinker; and (3) adding a secondary crosslinker to a crosslinked base polymer system. In embodiments, the crosslinked synthetic polymer gel can be in the form of a base polymer—dialdehyde system, a polymer pair system, a hydrophobically associating base polymer with a tunable surfactant, or a crosslinked base polymer. A formulation comprising such a crosslinked synthetic polymer gel can be used for various oilfield applications, for example, for suspending and transporting proppants.

In embodiments, the crosslinked synthetic polymer gel fluid in accordance with these systems and methods comprises an aqueous fluid containing at least one base polymer and at least one crosslinker. The base polymer can comprise a synthetic polymer, or a polymer that can be manufactured by polymerization of synthetic monomer units. In embodiments, the base polymer can be a polyacrylamide, a copolymer of acrylamide or methacrylamide with anionic and cationic comonomers, or a copolymer of acrylamide or methacrylamide with hydrophobic comonomers, acrylic acid, acrylamidomethylpropane-2-sulfonic acid (AMPS), and salts thereof. In other embodiments, the base polymer can be a hydrophobically-associating swellable emulsion (HASE) polymer. The base polymer can be delivered to the fluid in the form of a powder, an emulsion, a dispersion, a gel, a latex, and the like. Preferably, for use in oilfield applications such as proppant suspension and transport, the base polymer is delivered into the makeup water in a way that results in rapid hydration or dissolution of the polymer. In the event that a powder or granular form of base polymer is used, a high shear mixing system can be used for effective wetting of the polymer particles. In embodiments, the base polymer is a copolymer of acrylamide with acrylic acid in salt form, where the copolymer has a molecular weight of about 2 to about 50 million. In embodiments, the base polymer is a water soluble or water swellable composition. In embodiments, the base polymer is a combination of two or more types of polymers, where at least one of the polymers is a synthetic polymer. The base polymer can be crosslinked at the time of polymerization, it can be crosslinked after polymerization, or both, to enhance the viscosity profile. In embodiments, the base polymer can be blended or reacted with a crosslinker before the base polymer is introduced into the makeup water, for example when the base polymer is in a concentrated form, such as a solution, emulsion, dispersion, or powder.

Advantageously, the crosslinked synthetic polymer gel is stable in the presence of brines and stable at elevated temperatures and pressures, since these conditions are commonly encountered in the field of hydraulic fracturing with proppant-laden gel fluids. As used herein, the term “stable gel” refers to a gel that maintains a viscosity of at least 200 cP when measured at a shear rate of 100 sec⁻¹, or that retains at least 20% of the viscosity or suspending properties after exposure to the brine and temperature conditions.

1. Synthetic Base Polymer/Dialdehyde System

In embodiments, a crosslinked synthetic polymer gel system in accordance with these systems and methods can be formed from a synthetic base polymer and a dialdehyde crosslinker. In embodiments, the system comprises a synthetic base polymer that is reactive with aldehydes, and a dialdehyde crosslinker. Exemplary dialdehyde crosslinkers can be selected from the group consisting of glyoxal, glutaraldehyde, succindialdehyde, adipaldehyde, dialdehyde starch, and the like. The synthetic base polymer for this purpose can be a polymer-containing amine, amide, carboxyl, alcohol, or thiol functional groups. In embodiments, the synthetic base polymer is an acrylamide copolymer with anionic or cationic groups. In embodiments, the synthetic base polymer is a copolymer of sodium acrylate and acrylamide.

A glyoxal crosslinked polyacrylamide gel system having a lower amount of crosslinker (400 ppm or 10% of polymer) tends to have a stable viscosity at temperatures between about 70° F. and 180° F., but it tends to lose viscosity as the temperature is increased above 180° F. But it was found that a high level, such as 2000 ppm initial glyoxal level in the gel system (or 60% of the base polymer) provided a gel that retained suspending properties after at least 1 hour exposure at 180° F. and is not prone to syneresis. In embodiments, a formulation can be prepared wherein the initial amount of glyoxal crosslinker is determined based upon the intended temperature exposure of the gel fluid. Once the temperature rises above 250° F., a lower amount a lower amount of glyoxal can be used to provide gel stability (e.g., a glyoxal loading of about 200 to 400 ppm or about 5 to about 10% of polymer), because the elevated temperature conditions drive the crosslinking reaction forward at an accelerated rate. For glyoxal crosslinked gel formulations that are to be used in high temperature wells, an additional ingredient that consumes excess glyoxal at an increased temperature can help stabilize the gel and prevent overcrosslinking.

In embodiments, an acid or a delayed acid can be added to a synthetic base polymer/dialdehyde gel system to improve its stability to elevated temperatures. Glyoxal crosslinked polyacrylamide requires a high initial pH (˜11) in order to form the crosslinks in the desired time window (1 to 5 minutes). However, high pH and elevated temperature can render the crosslinked system unstable, so that it quickly loses viscosity. When acid is added following gel formation, the resulting gel was stable at elevated temperatures. In embodiments, a delayed acid can be added, i.e., a controlled-release acidic species that is encapsulated or otherwise formulated such that it does not release the acidity immediately; the acid in a delayed acid is released after some time in water or after reaching a certain trigger temperature. Using a delayed acid permits the controllable adjustment of pH as a function of time, temperature, or other stimulus.

Desirably, a gel to be used for proppant suspension has a rheological yield value that permits the suspension of a suitable number of proppant particles, where the proppant particles have a suitable size and density. Guar/borate fluids have been widely used for proppant suspension, and their rheological characteristics are well-accepted. In embodiments, crosslinked synthetic polymer gel systems as disclosed herein, e.g., polyacrylamide/glyoxal systems, have higher rheological yield values than guar/borate fluids, so that they are able to suspend more proppant particles or larger proppant particle size. The improved rheological characteristics of these polyacrylamide/glyoxal systems can improve proppant transport by preventing sedimentation of the proppant from the gel fluid.

While a more viscous gel can be advantageous for suspending proppant particles, viscosity can interfere with the process of pumping the fluid into the well. Fracturing fluid gels need to be pumped down the well bore to carry proppant into fractures created in reservoir via high pressure pumping and/or perforations. Since gels are high viscosity fluids, pumping such a fluid can result in a higher surface treating pressure and ultimately increased pump demand. A gel system that exhibits lower shear stresses at the high shear rates experienced during pumping down the wellbore can lower the surface treating pressure that is required and thus reduce pump demand. Advantageously, a gel to be used for proppant suspension would provide less friction losses at higher shear rates, thus requiring less pumping energy. When compared to guar/borate systems, the synthetic base polymer/dialdehyde crosslinker systems disclosed herein have demonstrated higher yield stress measurements (indicating better proppant suspension), but lower overall viscosity. At elevated shear rates (>500 sec⁻¹), as might be found during pumping, there is an unexpected decrease in shear stress. Advantageously, these gels regain or retain their suspension capabilities after the shear exposure when allowed to rest.

An important aspect of fracturing gels is the ability to degrade the polymer once the gel has served its purpose of delivering proppant to the fracture. Residual polymer can result in reduced permeability of the petroleum-bearing reservoir and consequently lower production rates due to this formation damage. Guar gum-based fracturing gels, for example, have as much as 10% insoluble impurities, which have been implicated in formation damage. By contrast, the synthetic base polymer/dialdehyde crosslinker systems as disclosed herein provide base polymers with high solubility, so that there is less potential damage to the formation from insoluble residua. In embodiments, these systems can also be treated with oxidizing agents that can degrade the polymer more rapidly. These oxidizing agents are familiar in the art, and are used at commonplace loading levels. Viscosity reduction of a polymer gel via an oxidizing agent demonstrates the ability to “break” the gel. The synthetic polymer—dialdehyde gel system as disclosed above can be “broken” by addition of ammonium persulfate (APS) or other oxidizing agents.

The synthetic polymer/dialdehyde system disclosed herein is compatible with makeup water that is contaminated with boron. Since boron-containing species can be found in make-up water and flowback water and the presence of boron has been shown to negatively impact the hydration and gel stability of guar gum based fracturing fluids, waters used in guar based fracturing fluids must contain little to no boron. The synthetic polymer/dialdehyde system disclosed herein does not have this restriction, making it easier to implement in areas where surface waters are known to have a higher boron concentration. It also presents the opportunity of using flowback water in gel formulation—reducing waste and water demand.

In embodiments, formulations comprising the synthetic polymer/dialdehyde gel fluids can be produced by hydrating the polymer, adding the selected crosslinker and alkali, adding other additives such as breakers, and allowing the components to react while pumping down the wellbore. In embodiments, the order of addition can be changed to optimize the results. Certain polymer crosslinking processes such as the synthetic polymer/dialdehyde system demonstrate higher efficiency of crosslinking when the polymer concentration is increased. This feature can result in the use of less polymer and crosslinker and improve gel stability at downhole temperatures.

In embodiments, one of two methods can be used to react the crosslinker with the base polymer while the base polymer is at a higher concentration than the final use level. The first method is to react the base polymer with crosslinker in the base polymer emulsion. In this method, the crosslinker can be added to the base polymer emulsion, along with some alkali, to cause crosslinking to occur in the emulsion form. The emulsion can be formulated to be compatible with liquid additions of this type by adjusting the emulsion surfactant compositions. The second method of reacting the crosslinker with the base polymer at higher concentration can be termed the split stream approach. The concept of split stream hydration for a hydraulic fracturing operation refers to a process of hydrating the base polymer in only part of the total make-up water, for example, half the volume of make-up water. This creates an environment of much higher polymer concentration than in the final fluid. Crosslinker and buffer could be introduced into the polymer fluid prior to combining with the remainder of the make-up water. At higher polymer concentrations, crosslinker and buffer will be utilized more efficiently, therefore requiring smaller volumes. Upon combination with the remainder of the make-up water, the total concentration of crosslinker in the system will be lower, reducing the chance of overcrosslinking. The dilution would also lower the pH closer to neutral, causing the gel to be more stable at higher temperatures.

The split stream hydration approach can be utilized to introduce crosslinker into a more concentrated solution of polymer, at or near the site of use, and then dilute the solution before or at the time of injection underground. For example, a 50 lb per 1000 gallon fluid can be formulated in a hydration tank and necessary amounts of buffer and crosslinker can be added to the hydration tank to begin the crosslinking reaction. The fluid can then be diluted with makeup water in the blender reducing the total polymer concentration to 25 lb per 1000 gallon fluid. The pH and total glyoxal concentration will also be lower since the crosslinker/buffer system is utilized more efficiently in the higher polymer fluid in the hydration tank.

2. Synthetic Base Polymer/Dialdehyde System Using Dual Crosslinkers

As previously disclosed, partially-hydrolyzed polyacrylamide can be crosslinked with glyoxal to form a viscous gel. However, as the gel temperature increases above 200° F. the crosslinked gel becomes unstable. Without being bound by theory, this appears to occur because, as the crosslink reverses or breaks, the glyoxal species can be consumed by a side reaction, preventing the crosslink bond from reforming. As a result the partially-hydrolyzed polyacrylamide/glyoxal gel loses viscosity rapidly at the temperatures of 220 to 300° F. It has been unexpectedly discovered that a synergistic combination of dialdehyde and organometallic crosslinkers for a synthetic base polymer/dialdehyde system can be used to make a gel that is more stable to elevated temperature conditions compared to either crosslinker used alone. In embodiments, exemplary organometallic crosslinkers can include transition metal ions, their salts, and chelated complexes thereof.

In embodiments, organometallic crosslinkers such as zirconate and titanate complexes/chelates are used to crosslink carboxyl and hydroxyl functional groups on polymers. The typical conditions to crosslink carboxyl functional groups with organometallic reagents are low pH, for example in the pH range of 4 to 7. The partially-hydrolyzed polyacrylamide/glyoxal reaction requires a higher pH environment, in the range of pH 9 to 12, to provide rapid gel formation. Under these elevated pH conditions a zirconate or titanate crosslinker would be ineffective at crosslinking partially-hydrolyzed polyacrylamide. Surprisingly, when combined with glyoxal, the organometallic crosslinker imparts high-temperature stability to the partially-hydrolyzed polyacrylamide based gel. Moreover, the combination of glyoxal and an organometallic crosslinker provides a significantly higher viscosity gel at high pH and high temperature than with either crosslinker alone when crosslinking a solution of partially hydrolyzed polyacrylamide.

Without being bound by theory, the improved viscosity of the dual crosslinker system may be a result of an interaction between the glyoxal and organometallic crosslinker. In solution glyoxal forms a hemiacetal species. The organometallic crosslinker may react with the hydroxyl groups on the hemiacetal while some of the remaining hemiacetal reacts with amide groups on the backbone polymer. A second possible explanation for the observed improved viscosity is that glyoxal at high temperature is converted into an acid species, effectively lowering the pH of the solution. The lower pH and elevated temperature then can drive the crosslink reaction of the organometallic species with the base polymer. In this way, glyoxal can serve as both a medium for achieving initial viscosity at low to medium temperatures, and as an activator for the organometallic crosslinking. The activity of the organometallic crosslinker is thus delayed by the high pH until the pH is reduced, which occurs as the temperature increases. Lab testing has shown that without the presence of glyoxal, the gel does not achieve the same high viscosity seen when glyoxal is included. Not to be bound by theory, it is believed that glyoxal's role in gel formation takes place in two steps. Initially, glyoxal can create a link between the amide groups on the base polymer. As temperature increases this bond becomes more reversible and the eventually breaks, leaving the glyoxal connected to one amide group; the unbound end of the glyoxal can then interact with the metal chelate.

An organometallic crosslinker useful for these purposes can be selected from the group consisting of titanium phosphate, titanium acetylacetonate, titanium alkanolamine, titanium lactate salts, zirconium alkanolamine, alkoxy zirconate, zirconium carbonate salts, and zirconium lactate salts. The organometallic crosslinker can also be selected from the group consisting of transition metal ions, their salts, and their chelated complexes with acetate, nitrilotriacetate, tartrate, lactates, citrate, triphenylphosphite, metaphosphite, gluconate, and phosphate.

In embodiments, a longer effective crosslink connection can improve the performance of a crosslinked gel. Addition of a small amount of a polymer or oligomer species with hydroxyl functionality, the crosslink extender, has been shown to improve crosslinked gel viscosity at higher temperatures (>250° F.). Without being bound by theory, a proposed mechanism for the observed improvement is that the metal chelate crosslinker interacts with the hydroxyl functional groups on the crosslink extender and also the hydroxyl groups of the glyoxal species in the hemiacetal conformation. It is proposed that the combination of glyoxal and metal chelate crosslinkers allows crosslinking to occur between the polyacrylamide base polymer and the crosslink extender. In this way the crosslink extender can effectively lengthen the link between polyacrylamide chains in solution.

In embodiments, the crosslink extender has hydroxyl functional groups able to be crosslinked by a metal chelate crosslinker. The crosslink extender can be a polysaccharide, a derivatized polysaccharide or a synthetic polymer or oligomer. Ideally the crosslink extender is completely soluble in water though in some cases it may be an insoluble fiber or microparticle. Possible crosslink extenders include: alginate, amylopectin, dextrin, cellulose, cellulose phosphate, cellulose sulfate, carboxymethyl cellulose, hydroxyethyl cellulose, hydroxypropyl cellulose, guar, carboxymethyl guar, hydroxypropyl guar, carboxymethylhydroxypropyl guar, polyethylene glycol, polyvinyl alcohol, carboxymethyl starch, xanthan gum.

The crosslink extender can be either a polymer or an oligomer containing hydroxyl functionality able to interact with the metal chelate crosslinker. The crosslink extender can be hydrated in water and added as a separate stream into the blender during a hydraulic fracturing operation. The crosslink extender can also be blended as a concentrate with the gel concentrate. By blending the crosslink extender in a concentrated form into the gel concentrate there would then be no need for an additional feed point during operation in the field. The crosslink extender would then be hydrated with the base polymer and delivered as one stream into the blender. In some cases the crosslink extender is available as an emulsion or slurry in oil. This is the preferred case in which the crosslink extender can easily be blended into the base polymer which is preferably an inverse emulsion polymer. In other cases it may be possible to obtain the crosslink extender in a powder or dry form. It is conceivable that the powder could be blended into the inverse emulsion of the base polymer. Another possible method for including the crosslink extender into the emulsion polymer would be to add the crosslink extender during the manufacturing of the base polymer. That is, to blend in the crosslink extender before, during or directly after inverse emulsion polymerization of the base polymer. The crosslink extender may be added to either the oil or aqueous phase prior to polymerization or added to the reactor vessel at the end of the polymerization batch. The crosslink extender is included in the formulation at a concentration of 1 wt % to 49 wt % based on the amount of the base polymer. More preferably, the crosslink extender is included at a concentration of 2 wt % to 20 wt % of the base polymer and most preferably from 2.5 wt % to 15 wt % of the base polymer.

In embodiments, the synthetic base polymer concentration in the fluid is 0.2 wt % to 0.8 wt % of the total fluid, and preferably 0.25 wt % to 0.4 wt %; the crosslinker concentration is 0.01 wt % to 0.5 wt % of total fluid, and preferably 0.03 wt % to 0.15 wt %.

In embodiments, the crosslinked synthetic polymer gels further embody an antioxidant or oxygen scavenger additive, such as may be selected from the group consisting of hydroquinone, dihydroxynaphthalene, thiosulfate salts, gallic acid, borax, citric acid, thiocyanate salts, ascorbic acid, glutathione, phenothiazine, thiourea, butylated hydroxyanisole (BHA), butylated hydroxytoluene (BHT), tocopherol, and monomethyl ether hydroquinone (MEHQ).

In embodiments, the crosslinked synthetic polymer gels can comprise a viscosity enhancer. In some situations, the addition of a viscosity enhancer can increase the viscosity and stability of the gel system. The effect of the viscosity enhancer can be attributed to how the enhancer interacts with chemical species already present in the make-up water. A viscosity enhancer can be selected so that it interacts with those soluble species in the make-up water that impair gel performance, by removing, precipitating, or chelating those species from the make-up water. Therefore, the viscosity enhancer improves gel performance. Species that could be incorporated as viscosity enhancers include sodium salts of aluminate, ethylenediaminetetraacetic acid, and also amino-tris-methylene phosphonic acid, 1-hydroxyethylidene-1,1-diphosphonic acid, 2-phosphonobutane-1,2,4-tricarboxylic acid, potassium aluminum sulfate, along with a variety of other precipitating and chelating agents.

3. Polymer Pair Systems

Whereas the systems and formulations above have relied upon the use of a single base polymer species, in other embodiments the base polymer component can comprise two or more complementary polymers of opposing charges and/or varying charge densities, where at least one of the base polymers is a synthetic polymer. The oppositely charged base polymers promote polymer overlap and ionic interaction to yield higher viscosity fluids and/or fluids that are more prone to crosslink via a covalent crosslink such as with glyoxal. Polymer pairing can be used to improve gel stability at higher temperatures. Also polymers with the same charge but varying charge densities can be combined for improved thermal stability and/or brine stability. Examples can include blending sulfonated p-AcAm with hydrolyzed p-AcAm.

Examples of anionic/cationic polymer pairing with synthetic and natural polymers include anionic polyacrylamides (p-AcAm) with 10-30 mol % anionic charge, carboxymethylcellulose (CMC), carboxymethylstarch (CMS), and the like. The cationic polymer that can pair with the anionic polymer can be a p-AcAm such as 1.5-10 mol % cationic p-AcAm, polyethylene glycol (PEG) amine adduct such as the Jeffamine series of products from Huntsman, polyvinyl amine, branched polyethylene imine, or linear polyethylene imine. The polymer pair, once formed, can be crosslinked with the dialdehydes such as glyoxal and glutaraldehyde. For example, CMC blended with a 5 mol % cationic p-AcAm results in increased viscosity when the two polymers are combined. In other embodiments of the polymer pair system, different charge density anionic polymers can be blended to improve viscosity after crosslinking.

4. Gel Systems Using a Crosslinked Base Polymer

In embodiments, a crosslinked synthetic polymer gel can be formed by a two-step process of (a) providing high molecular weight base polymers with relatively low levels of crosslinking, and (b) adding additional crosslinking features to the base polymer. The degree of total crosslinking in these two steps will ultimately control the gelling properties of these polymers in water. In embodiments, such crosslinked base polymers can be obtained by radical polymerization of monomers such as, but not limited to, acrylamide, methacrylamide, acrylic acid and the salts thereof, methacrylic acid and the salts thereof, acrylamidomethylpropane sulfonic acid and the salts thereof, and other vinyl carboxylic or sulfonic acids and their salts, and amine monomers selected from the group consisting of methacrylamidopropyltrimethylamine, acrylamidopropyltrimethylamine, acryloyloxyhydroxypropyltrimethylamine, methacryloyloxyhydroxypropyltrimethylamine, acryloyloxyethyltrimethylamine, methacryloyloxyethyltrimethylamine and their salts, diallyldimethylammonium chloride or sulfate, diacetone acrylamide, N-alkyl substituted acrylamides, and alkoxylated (meth)acrylates. An exemplary crosslinked base polymer is Carbopol 980 (Noveon), a water soluble crosslinked polyacrylic acid. The crosslinked base polymer can have crosslinking features that are covalent bonds, ionic bonds, or hydrophobic associations. Another example of the crosslinked base polymer is the superabsorbent type polymers, for example the crosslinked polymers of acrylic acid and acrylamide that are capable of swelling by many times their weight upon contact with water. The crosslinking can be obtained by introducing in the formulation monomers with more than one reactive group such as methylene bisacrylamide, polyethylene glycol diacrylate and dimethacrylates, etc.

In other embodiments, a crosslinked base polymer can be a hydrophobically associative water-soluble polymer and the additional crosslinker can be a tunable surfactant to form gels that are stable at high temperatures. The hydrophobically associative water-soluble polymer can comprise a hydrophilic long-chain backbone, with a small number of pendant hydrophobic groups localized along the chain. Examples of these polymers are the Superpusher product line from SNF which are water soluble polyacrylamides with hydrophobic sequences statistically distributed. The tunable surfactants can comprise water soluble molecules with hydrophobic groups at both ends of the molecule or randomly pendant from the polymer chain. Preferably the surfactant is a triblock oligomer in which a hydrophilic unit is located in the middle and 2 hydrophobic units located in both ends of the molecule. One characteristic of advantageous tunable surfactants is a cloud point that makes them become less water-soluble at higher temperatures, for example some of these materials have a cloud point above 40° C., or even above 90° C. A gel can be formed by dissolving the associative polymer and tunable surfactant in water. The hydrophobic groups of both species will aggregate minimizing their water exposure and forming intramolecular and intermolecular associations that give rise to a three-dimensional network and, consequently, increasing the viscosity of the solution. The surfactant can bridge polymer chains together to enhance the interpolymer hydrophobic interaction. The relatively small size of the surfactants, in comparison to the polymer, provides them with great mobility, which facilitates their ability to form new bridges easily. In addition, as the temperature increases and the cloud point of the molecule is reached, the surfactant will tend to lose solubility in water. As a result, the surfactant molecules that are interacting with the polymer chains by hydrophobic interaction will become stiffer, resulting in a more rigid gel at higher temperatures.

In an embodiment, a crosslinked superabsorbent polymer can be used in combination with the crosslinked synthetic polymer gels disclosed herein. In this embodiment, the superabsorbent polymer can absorb a fraction of the available makeup water, such that the remaining water becomes the diluent for the crosslinked synthetic polymer gel. Since the superabsorbent polymer occupies some of the water volume, the net effect is that the crosslinked synthetic polymer gel is present at a higher concentration in the remaining fluid available to dissolve the gel. The higher concentration of the polymer gel results in a higher viscosity of the overall fluid, and improved proppant suspension abilities.

Guar gum, as used in common practice, does not hydrate and dissolve effectively in water containing alkali and crosslinking agents. Therefore it is advantageous to first introduce the guar gum into the make-up water in a mixing tank known as a hydration unit; this allows the guar to hydrate and dissolve in the water for several minutes prior to blending with other fluid additives. The need for a hydration unit adds to the complexity of the operation. It would be desirable to have a fracturing gel system in which the base polymer could be added directly to the blender and without the need for a hydration unit. It has been found that, with the gel system as disclosed herein, the synthetic base polymer can be added into make-up water simultaneously with the crosslinkers and buffer, and without the need for a hydration unit. The polymer is still able to hydrate enough to be crosslinked and form a gel. In some cases a surfactant can be dissolved in the make-up water prior to addition of the polymer to the blender to improve the rate or extent of hydration.

Surfactants typically aid in the hydration of the high molecular weight synthetic polymer. With the addition of the surfactant, the hydration can take less than 5 minutes. In most water sources >90% of the gel base polymer of the formulations disclosed herein can be hydrated in about 1 to 2 minutes with a suitable surfactant when added as a liquid concentrate or in an emulsion form. This reduction in hydration time enables the polymer to be added directly to the blender and left to fully hydrate while being pumped down the vertical section of the well. The type and concentration of the surfactant can control the hydration time of the gel base polymer. A number of suitable surfactants can be used. For example, a nonionic surfactant such as an ethoxylated alcohol can be used. As another example, an ethoxylated lauryl alcohol (commercially available from Ethox Chemicals) can be used. Another exemplary surfactant comprises alkoxy poly(ethyleneoxy)ethanol, an ethoxylated alcohol having from 8 to 14 carbon molecules, and combinations thereof.

A number of functionalities for the crosslinked synthetic polymer gels as disclosed herein would be apparent to those having ordinary skill in the art. For example, the crosslinked synthetic polymer gels as disclosed herein can be used in a method of improving production from an oil or gas well, by improving the efficiency or placement of proppant, or by encouraging longer fractures (known to result from lower viscosity or shear thinning fracturing fluids) rather than wider fractures (known to result from higher viscosity fracturing fluids). As another example, the crosslinked synthetic polymer gels as disclosed herein can be used in a method of water blocking or water shutoff, for example the synthetic polymer and dual crosslinker system (dialdehyde+organometallic reagent) is more stable to high temperature conditions when compared with either crosslinker alone. In another example, the crosslinked synthetic polymer gels as disclosed herein can be used in a method of enhanced oil recovery, where a viscous plug flow of the water phase reduces or prevents the occurrence of fingering in a reservoir. In another example, the crosslinked synthetic polymer gels as disclosed herein can be used in a method of treating a formation to reduce sand production, often called “formation consolidation.” In yet another example, the crosslinked synthetic polymer gels as disclosed herein can be used in a method of displacing fluid from a wellbore by viscous plug flow.

### EXAMPLES

### Materials

DCF05 (Polymer Ventures, Inc., Charleston, S.C.)
Aquabloc, Sodium Carboxymethyl Starch (CMS) (Aquasol Corp., Rock Hill, S.C.)
Flopam EM 430 (SNF, Inc., Riceboro, Ga.)
Sodium Bicarbonate (Sigma-Aldrich, St. Louis, Mo.)
Sodium Hydroxide (Sigma-Aldrich, St. Louis, Mo.)
Glyoxal, 40 wt % (Sigma-Aldrich, St. Louis, Mo.)
Carbopol 980 (Noveon, Cleveland, Ohio)
Poly(acrylic acid), partial potassium salt, lightly crosslinked (Sigma-Aldrich, St. Louis, Mo.)
Hydrogen Chloride, 37 wt % (Sigma-Aldrich, St. Louis, Mo.)
Tyzor LA (Dorf Ketal Specialty Catalysts LLC, Stafford, Tex.)
Tyzor 217 (Dorf Ketal Specialty Catalysts LLC, Stafford, Tex.)
Ammonium Zirconium Bicarbonate Solution (Sigma-Aldrich, St. Louis, Mo.)
Glutaraldehyde grade II, 25 wt % (Sigma-Aldrich, St. Louis, Mo.)
Hydroquinone (Alfa Aesar, Ward Hill, Mass.)
HAF43 (Polymer Ventures Inc., Charleston, S.C.)
Potassium Chloride Pellets (Morton Salt, Chicago, Ill.)
Sodium Tetraborate Decahydrate (Alfa Aesar, Ward Hill, Mass.)
50 wt % Hydrogen Peroxide in water (Sigma-Aldrich, St. Louis, Mo.)
Ammonium Persulfate (APS) (Sigma-Aldrich, St. Louis, Mo.)
Boric Acid (Sigma-Aldrich, St. Louis, Mo.)
Glycerin 99.7% USP K (Avatar Corp, University Park, Ill.)
Progel 4.5 (International Polymerics Inc., Dalton, Ga.)
Ethal LA-12/80 (Ethox Chemicals, Greenville, S.C.)
Magnesium Peroxide (Sigma-Aldrich, St. Louis, Mo.)
Sodium silicate (Sigma-Aldrich, St. Louis, Mo.)
Sodium aluminate, 38% solution (USALCO LLC, Baltimore, Md.)

### Example 1

### Polymer Pairing

Stock 0.5 wt % DCF05 solution was formulated by dissolving dry powder in sufficient tap water at 800 rpm using caged impellor/overhead stirrer. DCF05 is a cationic polyacrylamide with a charge density of 1.5 mol %. Stock 0.5 wt % carboxymethyl cellulose (CMS) solution was formulated by dissolving dry powder in sufficient tap water at 800 rpm using caged impellor/overhead stirrer. CMS is an anionic starch with a charge density of 50 mol %. Samples of a total mass of 170 g were mixed by adding the lower mass polymer solution to the higher mass polymer solution while mixing with an overhead stirrer at 800 rpm. The polymer pair solutions were allowed to mix for approximately 5 minutes. Viscosity measurements were taken using an OFITE Model 800 Viscometer with an R1B1F1 configuration (see Table 1 below).

TABLE 1
Polymer Pair Viscometer Readings

| Sample | 0.5% CMS | 0.5% DCF05 | Dial Reading (lb/100 ft²) | | |
|---|---|---|---|---|---|
| # | % wt | % wt | 600 rpm | 300 rpm | 100 rpm |
| 1 | 0 | 100 | 28 | 18.5 | 10 |
| 2 | 25 | 75 | 10 | 6 | 3 |
| 3 | 50 | 50 | 5 | 3 | 2 |
| 4 | 75 | 25 | 16 | 9 | 3.5 |
| 5 | 85 | 15 | 14 | 8 | 3.5 |
| 6 | 100 | 0 | 11 | 7 | 3 |

### Example 2

### Ionic Polymer Pairing

A stock solution of 2 wt % CMS was prepared by dissolving 24 g CMS in 1200 g tap water with adequate mixing. A stock solution of 0.5 wt % DCF05 was prepared by dissolving 2.25 g DCF05 in 450 g tap water with adequate mixing. Different formulations were prepared by blending the two solutions together at various ratios and concentrations. The viscosity of each combination was measured using a Fann 35 viscometer at three different speeds using the R1B1F1 configuration. Dial readings are reported in Table 2 for each combination. Shear stress values are in lb/100 ft².

TABLE 2
Polymer Pair Viscosities

| | 2% CMS | 0.5% DCF05 | Tap Water | | | |
|---|---|---|---|---|---|---|
| Sample | (g) | (g) | (g) | 600 rpm | 300 rpm | 3 rpm |
| A | 30 | 18 | 102 | 21 | 12 | <1 |
| B | 40 | 24 | 86 | 28 | 17 | 1 |
| C | 60 | 36 | 54 | 50 | 39 | 2 |
| D | 75 | 45 | 30 | 85 | 73 | 5 |
| E | 100 | 60 | 0 | 95 | 80 | 7 |
| F | 68 | 41 | 61 | 54 | 38 | 3 |
| G | 85 | 51 | 34 | 105 | 85 | 7 |
| H | 170 | 0 | 0 | 60 | 38 | 2 |
| I | 0 | 170 | 0 | 27 | 18 | 2 |

### Example 3

### Gel Stability at 180° F.

Flopam EM 430 is a partially hydrolyzed polyacrylamide emulsion polymer (about 30% actives) having a charge density of approximately 10 mol %. Stock polymer solutions were prepared by inverting Flopam EM 430 in tap water. A 1.3 wt % solution was prepared by adding 6.7 g polymer to 493 g tap water. A 1 wt % solution was prepared by adding 5 g polymer to 495 g tap water. Solutions were mixed until polymer was fully dissolved. A stock buffer solution was prepared by dissolving 25.2 g sodium bicarbonate and 11.4 g sodium hydroxide in 300 mL tap water. Stock glyoxal solution was prepared by diluting 40 wt % glyoxal 1:1 with tap water to yield a 20 wt % solution.

Gels were screened as 50 g samples. To 200 g of polymer solution was added 3.75 mL of buffer. The solution was stirred and split into four 50 g samples in 100 mL beakers. Glyoxal was added in different amounts to each sample and the mixture was stirred by hand with a spatula until a gel formed (approximately 10 minutes). To the surface of the gel was added 1 g of 20/40 mesh frac sand. The beakers were then covered with aluminum foil and placed in an oven at 80° C. Samples were visually inspected over the course of 1 hour to assess suspension of gel while heating (See Table 3). Tests were stopped if all of the sand had settled to the bottom of the beaker.

TABLE 3
Gel Performance at 80° C.

| Polymer | Glyoxal | | | | |
|---|---|---|---|---|---|
| Conc. | Conc. | Sand Suspension | | | |
| (% wt) | (ppm) | 15 min | 30 min | 45 min | 60 min |
| 1.3 | 1000 | Suspended | Settled | n/a | n/a |
| 1.3 | 1500 | Suspended | Partially | Settled | Settled |
| | | | Suspended | | |
| 1.3 | 2000 | Suspended | Suspended | Suspended | Suspended |
| 1.3 | 2500 | Suspended | Suspended | Suspended | Suspended |
| 1.0 | 1500 | Suspended | Suspended | Settled | Settled |
| 1.0 | 2000 | Suspended | Suspended | Suspended | Suspended |

Suspended = all sand remained on top of gel;
Partially Suspended = sand was in middle of gel but bad not settled to bottom of beaker
Settled = all sand is at bottom of beaker

### Example 4

### Viscosity Profiles at 180° F.

A stock 1% Flopam EM 430 polymer solution was formulated by mixing 5 g EM 430 in 495 g tap water with an overhead stirrer. Stock buffer was formulated as described in the previous example.

Viscosity measurements were conducted using Ametek Chandler's Model 3500 viscometer equipped with a Fann Thermocup and a R1B2F1 rotor/bob/spring configuration. To 180 g 1% polymer solution were added 3.6 mL of buffer while stirring. The pH after buffer addition was about 10.8. Glyoxal was then added to the mixture and stirred in for about 40 seconds. The solution was then loaded into the viscometer and the Thermocup set to the “High” setting. The viscometer was then turned on at a speed of 300 rpm and allowed to run continuously at that speed for 1 hour. Dial readings were taken throughout the course of the run (see Table 4). For a typical viscosity measurement the temperature reached 180° F. in about 4 minutes and remained at temperature for the duration of the test.

TABLE 4
Viscosity Measurements

| | Time (min) | | | | | | | | |
|---|---|---|---|---|---|---|---|---|---|
| | 1 | 2 | 3 | 5 | 10 | 15 | 30 | 45 | 60 |
| 300 ppm | 62 | 71 | 71 | 125 | 71 | 36 | 36 | 36 | 36 |
| Glyoxal | | | | | | | | | |
| (cP) | | | | | | | | | |
| 2000 ppm | 62 | 89 | 249 | 240 | 383 | 356 | 276 | 249 | 223 |
| Glyoxal | | | | | | | | | |
| (cP) | | | | | | | | | |

### Example 5

### Acid Stabilized Gel

Stock 1.3 wt % Flopam EM 430 was made by inverting 6.7 g emulsion polymer in 493 g tap water while stirring at 800 rpm for 1 hour with an overhead stirrer. Stock buffer was formulated as described in a previous example. Stock 5M HCl was made by diluting 37 wt % HCl with tap water.

To 200 g of polymer solution was added 3.75 mL of buffer while stirring. The pH after buffer addition was about 10.8. Resulting mixture was separated into four 50 g samples in 100 mL beakers. Glyoxal was added to each sample and sample was mixed and allowed to form a gel (˜10 minutes). Once gel formation occurs acid was mixed into the gel. About 1 g of 20/40 mesh frac sand was placed on top of the gel, the beaker was covered with aluminum foil and placed in an oven at 80° C. Samples were assessed for suspension properties over the course of 1 hour (see Table 5).

TABLE 5
Observations of Acid Stabilized Gel at 80° C.

| Glyoxal Conc. | 5M HCl | Sand Suspension | | | |
|---|---|---|---|---|---|
| (ppm) | (mL) | 15 min | 30 min | 45 min | 60 min |
| 400 | 0 | Partially | Settled | Settled | Settled |
| | | Suspended | | | |
| 400 | 0.2 | Suspended | Suspended | Suspended | Partially |
| | | | | | Suspended |
| 400 | 0.6 | Suspended | Suspended | Suspended | Suspended |
| 800 | 0.2 | Suspended | Suspended | Suspended | Partially |
| | | | | | Suspended |

Suspended = all sand remained on top of gel;
Partially Suspended = sand was in middle of gel but bad not settled to bottom of beaker
Settled = all sand is at bottom of beaker

### Example 6

### Viscosity Profile for Acid Stabilized Gel

To samples of 180 g of 1 wt % Flopam EM 430 was added 3.5 mL of buffer solution and 0.5 mL of a 5M sodium hydroxide solution. The 5M sodium hydroxide solution was prepared in advance by dissolving 20 g sodium hydroxide pellets in 100 mL tap water. Solution pH after buffer addition was about 12. Samples were then loaded into the Chandler 3500 viscometer fitted with a R1B2F1 configuration and glyoxal added at a concentration of 2000 ppm to crosslink the polymer solution. The Thermocup was turned on to the highest setting and the viscometer operated at a speed of 300 rpm. Acid was added to the sample about 4 minutes into the viscosity profile. Results from the viscosity profiles are reported in Table 6.

TABLE 6
Acid Stabilized Viscosity Profiles

| | Time (min) | | | | | | | | |
|---|---|---|---|---|---|---|---|---|---|
| | 1 | 2 | 3 | 5 | 10 | 15 | 30 | 45 | 60 |
| Temp (° F.) | 70 | 90 | 140 | 180 | 180 | 180 | 180 | 180 | 180 |
| Viscosity with | 89 | 802 | 1176 | 1158 | 962 | 775 | 347 | 223 | 125 |
| No Acid (cP) | | | | | | | | | |
| Viscosity with | 178 | 757 | 891 | 891 | 784 | 659 | 428 | 312 | 223 |
| 300 ppm HCl (cP) | | | | | | | | | |
| Viscosity with | 312 | 757 | 980 | 1024 | 739 | 695 | 525 | 374 | 267 |
| 600 ppm HCl (cP) | | | | | | | | | |

### Example 7

### Glutaraldehyde Crosslink

Solutions of 1.3 wt % Flopam EM 430 and sodium hydroxide/sodium bicarbonate buffer were prepared as described in previous examples. Glutaraldehyde was used as a 20 wt % solution in water. To 300 g of a 1.3 wt % Flopam EM430 solution was added 6 mL of buffer and the resulting mix was stirred to homogenize. The sample was then split into five 50 g samples in 100 mL beakers. Glutaraldehyde was added to the samples in varying concentration and samples were stirred by hand with a spatula following glutaraldehyde addition. Visual observations were recorded regarding the extent of gelation that occurred in each sample (see Table 7).

TABLE 7
Glutaraldehyde Crosslinked System

| Glutaraldehyde | |
|---|---|
| (ppm) | Observations |
| 400 | No Gel |
| 1000 | Weak Gel |
| 2000 | Weak Gel |
| 6000 | Gel |

No Gel = No significant viscosity increase
Weak Gel = Noticeable viscosity increase but solution is still stringy
Gel = Continuous gel that can be picked up out of beaker with a spatula

### Example 8

### Yield Value Measurements

Stock 3% potassium chloride (KCl) solution was prepared by dissolving about 30 g potassium chloride pellets in 1000 mL deionized water. A 45 lb/Mgal guar solution was prepared by adding 2.8 mL of a 4 lb/gal guar diesel slurry provided by an oilfield service company for every 250 g of 3% KCl solution. The guar was hydrated by blending in a Black & Decker blender on the lowest speed setting for about 2 minutes. A 2% sodium tetraborate decahydrate solution was prepared by dissolving 2 g of sodium tetraborate decahydrate in 100 mL of tap water. Crosslinked guar gels were achieved by adding about 5 mL of a 2% sodium tetraborate decahydrate solution to 250 g of a 45 lb/Mgal guar solution in 3% KCl and mixing by hand with a spatula. A polymer solution with comparable active polymer concentration to a 45 lb/Mgal guar solution was prepared using HAF43 anionic emulsion polymer. HAF43 solution in 3% KCl was prepared by adding about 8.8 g HAF43 to about 492 g 3% KCl and stirring with an overhead stirrer to until the polymer was fully inverted. Solution pH was adjusted to about 10.8 with buffer before crosslinking. To form a gel about 1 mL of a 10 wt % glyoxal solution was added to about 200 g of the pH adjusted HAF43 solution and stirred with a spatula.

Gels were tested using a Brookfield YR-1 Rheometer equipped with either the V-71 or V-72 vane spindle and the corresponding pre-programmed test V-71 half-way or V-72 half-way. Gels were placed in a 300 mL beaker, stirred by hand and then placed in the viscometer so that the vane was submerged half-way into the gel. The final yield value was recorded in pascal units (Pa). The V-72 vane was used for the HAF43 gels because the yield value exceeded the upper limit of the measurement range for the V-71 vane. Each gel was tested three times, mixing the gel by hand with a spatula in between each test (see Table 8).

TABLE 8
Yield Value Results

| Polymer | Guar | HAF43 |
|---|---|---|
| Concentration (lb/Mgal) | 45 | 45 |
| Test Vane | V-71 | V-72 |
| Yield Value 1 (Pa) | 24.7 | 46.3 |
| Yield Value 2 (Pa) | 27.5 | 47.2 |
| Yield Value 3 (Pa) | 23 | 54.9 |

### Example 9

### Gel Formation with Different Buffers

This example demonstrates the ability to adjust crosslink formation time and extent by adjusting the pH of the system. Stock 1% Flopam EM430, sodium hydroxide/sodium bicarbonate buffer, 5M sodium hydroxide, and 20 wt % glyoxal solutions were formulated as described in a previous example and used in this example. Three 180 g samples of 1% Flopam EM430 were treated with different amounts of alkali. Test 1 was treated with 3.6 mL of buffer achieving a pH of 11. Test 2 was treated with 3.5 mL of buffer and 0.2 mL of 5M sodium hydroxide achieving a pH of 11.7. Test 3 was treated with 3.5 mL of buffer and 0.5 mL of 5M sodium hydroxide achieving a pH of 12.1. Samples were crosslinked with 1.8 mL of 20 wt % glyoxal, loaded into the Chandler 3500 viscometer equipped with a Thermocup and a viscosity profile at 180° F. was conducted. The viscometer was operated using a R1B2F1 configuration at a speed of 300 rpm (see Table 9).

TABLE 9
Impact of pH on Viscosity Profile

| | Time (min) | | | | | | | | |
|---|---|---|---|---|---|---|---|---|---|
| | 1 | 2 | 3 | 5 | 10 | 15 | 30 | 45 | 60 |
| Temp | 70 | 90 | 140 | 180 | 180 | 180 | 180 | 180 | 180 |
| (° F.) | | | | | | | | | |
| Test 1 | 62 | 89 | 249 | 240 | 383 | 356 | 276 | 249 | 223 |
| (cP) | | | | | | | | | |
| Test 2 | 62 | 534 | 401 | 579 | 534 | 445 | 321 | 258 | 187 |
| (cP) | | | | | | | | | |
| Test 3 | 89 | 802 | 1176 | 1158 | 962 | 775 | 347 | 223 | 125 |
| (cP) | | | | | | | | | |

### Example 10

### Breaking of Polyacrylamide with Oxidizing Agents

This example demonstrates the ability to break a gel having a polyacrylamide backbone polymer using oxidizing agents. Stock solutions of 10 wt % ammonium persulfate (APS) and 10 wt % hydrogen peroxide were prepared by dissolving 1 g APS in 9 g tap water and diluting 2 g of 50 wt % hydrogen peroxide with 8 g tap water respectively. Stock 1.3 wt % Flopam EM430 and sodium hydroxide/sodium bicarbonate buffer was prepared as described in a previous example.

Both crosslinked and uncrosslinked polymer solutions were treated with a small amount of oxidizing agent. For uncrosslinked polymer solutions, 0.2 mL of the oxidizing agent solution was added to 200 g of polymer solution in a 300 mL beaker and stirred with a spatula for about 1 minute. The beaker was then covered with aluminum foil and placed in an oven at 80° C. After 1 hour the polymer solution was removed from the oven and allowed to cool down to ambient temperature (about 75° F.). A viscosity measurement was then taken using a Brookfield DV-III+ viscometer with a LV-II spindle at 30 rpm. For crosslinked systems 180 g of polymer solution in a 300 mL beaker was treated with 3.6 mL of buffer while stirring followed by the addition of 0.18 mL of breaker solution and 1.8 mL of 20 wt % glyoxal to crosslink. Beaker was then covered with aluminum foil and placed in an oven at 80° C. After 1 hour the beaker was removed and allowed to cool down to ambient temperature. A viscosity measurement was then taken using a Brookfield DV-III+ viscometer with a LV-II spindle at 30 rpm. See Table 10 for final viscosity values.

TABLE 10
Breaker Test Viscosities

| | | Final Viscosity |
|---|---|---|
| System | Additive | (cP) |
| Uncrosslinked | No Breaker | 351 |
| Uncrosslinked | 0.01 wt % H₂O₂ | 402 |
| Uncrosslinked | 0.01 wt % APS | 10 |
| Crosslinked | No Breaker | 223 |
| Crosslinked | 0.01 wt % H₂O₂ | 201 |
| Crosslinked | 0.01 wt % APS | 44 |

### Example 11

### Viscosity Profile in Presence of Brine/Boron

Stock sodium hydroxide/sodium bicarbonate buffer was prepared and used as described in a previous example. A stock solution of 2% KCl and 100 ppm boron was prepared as a synthetic make-up water in which to test the proposed gel system by dissolving 20 g KCl and 0.58 g boric acid in 979 g of tap water. A solution of Flopam EM 430 was prepared by adding 5.7 mL of the polymer to 500 mL of the synthetic make-up water in a Black & Decker blender on the lowest speed setting using a variable transformer to control the speed of the mixing blade. A second polymer solution was prepared by adding 4.8 mL Kemira A4251 to 500 mL of the synthetic make-up water and mixing in the blender. To a 180 g sample of the Flopam EM 430 solution were added 1 mL of buffer and 2 mL of 1M sodium hydroxide. To a 180 g sample of the Kemira A4251 were added 1.8 mL of buffer and 0.3 mL of 5M sodium hydroxide. Each sample was then crosslinked with 0.8 mL 40 wt % glyoxal. After adding glyoxal the gel was stirred with a spatula for about 40 seconds and then loaded into the Chandler 3500 viscometer equipped with a Fann Thermocup. The Thermocup was turned on to the “high” setting and the viscometer was operated at 300 rpm with a R1B2F1 configuration to generate viscosity profiles for each sample at 180° F. (see Table 11).

TABLE 11
Viscosity Profiles in Brine/Boron

| | Time (min) | | | | | | | | |
|---|---|---|---|---|---|---|---|---|---|
| | 1 | 2 | 3 | 5 | 10 | 15 | 20 | 30 | 45 |
| Temp | 70 | 90 | 140 | 180 | 180 | 180 | 180 | 180 | 180 |
| (° F.) | | | | | | | | | |
| A4251 | 53 | 151 | 490 | 623 | 1336 | 1291 | 1246 | 1042 | 855 |
| (cP) | | | | | | | | | |
| Flopam | 45 | 89 | 232 | 312 | 623 | 623 | 713 | 668 | 606 |
| EM430 | | | | | | | | | |
| (cP) | | | | | | | | | |

### Example 12

### Crosslink in the Base Polymer Emulsion

This example demonstrates the ability to crosslink a polymer in a water-in-oil emulsion by adding a small amount of dilute glyoxal and optionally a small amount of alkali directly to an inverse emulsion polyacrylamide, allowing significant amount of time for the reaction to occur and inverting the polymer in water.

Stock 0.05 wt % glyoxal in water was prepared by first preparing a 1 wt % glyoxal solution by diluting 0.25 g of 40 wt % glyoxal with tap water to a final mass of 10 g. Then 0.5 g of the 1 wt % solution was diluted with tap water to a final mass of 10 g. Stock 1M sodium hydroxide was prepared by dissolving 4 g sodium hydroxide pellets in 100 g tap water. Samples of 5 g Flopam EM 430 in 20 mL scintillation vials were treated with varying amounts of glycerol, 0.05 wt % glyoxal and 1M sodium hydroxide. Upon addition of the additives to a sample the sample was vortex mixed for about 2 minutes to fully disperse the crosslinker and alkali throughout the aqueous phase of the inverse emulsion polymer. Samples were allowed to sit at room temperature for five to six days. Samples were tested by adding 2 g of the sample to 198 g deionized water and mixing with an overhead stirrer to fully invert the polymer. The viscosity of the polymer solution was measured using a Brookfield DV-III+ rheometer equipped with a LV-II spindle at a speed of 30 rpm (see Table 12).

TABLE 12
In-Emulsion Crosslinking

| | Glycerol | Glyoxal Conc. | 1M NaOH | Hold Time | Brookfield |
|---|---|---|---|---|---|
| Sample | (g) | (meq/mol) | (mL) | (days) | Visc. (cP) |
| 12-1 | 0 | 0.1 | 0.02 | 5 | 438 |
| 12-2 | 0 | 0.1 | 0.05 | 5 | 400 |
| 12-3 | 0 | 0.1 | 0.1 | 5 | 297 |
| 12-4 | 0 | 0.1 | 0 | 5 | 471 |
| 12-5 | 0 | 0.05 | 0.02 | 5 | 470 |
| 12-6 | 0 | 0.05 | 0.05 | 5 | 485 |
| 12-7 | 0 | 0.05 | 0.1 | 5 | 449 |
| 12-8 | 0 | 0.05 | 0 | 5 | 465 |
| 12-9 | 0.2 | 0.05 | 0.02 | 5 | 455 |
| 12-10 | 0.2 | 0.05 | 0.05 | 5 | 456 |
| 12-11 | 0.2 | 0.05 | 0.1 | 6 | 483 |
| 12-12 | 0.2 | 0.05 | 0 | 6 | 454 |
| 12-13 | 0 | 0 | 0 | 0 | 411 |

### Example 13

### Dual Crosslinker Stability at 120° C.

A stock buffer solution was prepared by dissolving 25.2 g sodium bicarbonate and 11.4 g sodium hydroxide in 300 mL tap water. A stock 1M sodium hydroxide solution was prepared by dissolving 4 g sodium hydroxide pellets in 100 mL of deionized water. Tyzor LA is a 50 wt % aqueous solution of an ammonium titanium lactate complex. A 15.2 gpt solution of Flopam EM 430 was prepared by adding 7.6 mL of the liquid emulsion polymer to 500 mL tap water in a Black & Decker blender while mixing. The “gpt” units refer to gallons of liquid additive per thousand gallons fluid. The solution was mixed for approximately 10 minutes and was used in subsequent testing. Multiple batches of the same polymer concentration were prepared to complete all of the tests. To each 200 g sample of the 15.2 gpt EM 430 solution was added 3 mL of the stock buffer solution and 0.4 mL of the 1M sodium hydroxide solution to achieve a pH of ˜11. Each sample was then crosslinked with glyoxal, titanate or a combination of the two, mixed for 10 minutes and transferred into a 350 mL bomb reactor. The gelled solutions were placed in an oven at 120° C. for 30 minutes. After 30 minutes the samples were removed from the oven and allowed to cool to about 30° C. The viscosity of the cooled samples was measured using a Chandler 3500 viscometer with a R1B2F1 configuration operated at a speed of 300 rpm (see Table 13).

TABLE 13
Dual Crosslinker Post-Heat Viscosities

| | Glyoxal | Titanate | |
|---|---|---|---|
| Sample | Solution (mL) | Solution (mL) | Viscosity (cP) |
| 1-1 | 0 | 0 | 80 |
| 1-2 | 0.095 | 0 | 67 |
| 1-3 | 0 | 0.159 | 67 |
| 1-4 | 0.095 | 0.159 | 1160 |
| 1-5 | 0.057 | 0.159 | 1113 |
| 1-6 | 0.190 | 0.159 | 1425 |
| 1-7 | 0.381 | 0.159 | 1068 |
| 1-8 | 0.095 | 0.024 | 400 |
| 1-9 | 0.095 | 0.079 | 1068 |
| 1-10 | 0.095 | 0.317 | 1959 |

### Example 14

### Dual Crosslinker Viscosity Profile

To a 200 g sample of 15.2 gpt Flopam EM 430 (prepared as described in above example) was added 3 mL stock buffer and 0.4 mL 1M sodium hydroxide to achieve a pH of 11. To the fluid was then added about 0.19 mL 40 wt % glyoxal and about 0.16 mL Tyzor LA. The fluid was stirred by hand with a spatula for about 1 minute and then about 170 mL of the fluid was loaded into a Chandler 3500 Viscometer equipped with a thermocup and a viscosity profile at 180° F. was conducted. The viscometer was operated using a R1B2F1 configuration at a speed of 300 rpm, and the results are shown in Table 14.

TABLE 14
Dual Crosslinker Viscosity Profile at 180° F.

| | Time (min) | | | | | | | | |
|---|---|---|---|---|---|---|---|---|---|
| | 1 | 2 | 3 | 5 | 10 | 15 | 30 | 45 | 60 |
| Temp | 70 | 90 | 140 | 180 | 180 | 180 | 180 | 180 | 180 |
| (° F.) | | | | | | | | | |
| Visc. | 178 | 222 | 383 | 668 | 783 | 801 | 1158 | 1069 | 998 |
| (cP) | | | | | | | | | |

### Example 15

### Dual Crosslinker Stability at 120° C. with AZC

Ammonium zirconium carbonate (AZC) was purchased from Sigma-Aldrich as a stabilized solution in water. To each 200 g sample of 15.2 gpt Flopam EM 430 (prepared as described in above example) was added 3 mL stock buffer and 0.4 mL 1M sodium hydroxide to achieve a pH of about 11. Samples were crosslinked with a combination of AZC and glyoxal, allowed to crosslink for 10 minutes and then transferred into 350 mL bomb reactors. Samples were heated in an oven at 120° C. for 30 minutes. After 30 minutes the samples were removed from the oven and allowed to cool to a temperature of about 30° C. The viscosity of the cooled samples was measured using a Chandler 3500 viscometer with a R1B2F1 configuration operated at a speed of 300 rpm (see Table 15).

TABLE 15
AZC Dual Crosslinker Stability at 120° C.

| | Glyoxal | AZC | |
|---|---|---|---|
| Sample | Solution (mL) | Solution (mL) | Viscosity (cP) |
| 3-1 | 0 | 0.150 | 67 |
| 3-2 | 0.095 | 0.150 | 1068 |

### Example 16

### Pre-Blending of Dual Crosslinker

Formulate a 1:1 by mass solution of glyoxal and titanate by blending 3.82 mL of 40 wt % glyoxal with 3.18 mL of Tyzor LA. Use this formulation as XLK1. Formulate a 1:2 by mass solution of glyoxal and titanate by blending 1.91 mL of 40 wt % glyoxal with 3.18 mL of Tyzor LA. Use this formulation as XLK2. Formulate a 1:1 by mass solution of glyoxal and AZC by blending 3.82 mL of 40 wt % glyoxal with 3.0 mL of AZC solution. Combination formed an insoluble precipitate. Formulate a 1:2 by mass solution of glyoxal and AZC by blending 1.91 mL of 40 wt % glyoxal with 3.0 mL of AZC solution. Use this formulation as XLK4. Treat samples of 200 g 15.2 gpt Flopam EM 430 (prepared as described in an above example) with 3 mL stock buffer and 0.4 mL 1M sodium hydroxide to achieve a pH of about 11. Crosslink samples with pre-blended crosslinker formulations and allow 10 minutes to crosslink. Transfer samples into 350 mL bomb reactors and place in oven at 120° C. for 30 minutes. After 30 minutes the samples were removed from the oven and allowed to cool to a temperature of about 30° C. The viscosity of the cooled samples was measured using a Chandler 3500 viscometer with a R1B2F1 configuration operated at a speed of 300 rpm (see Table 16).

TABLE 16
Pre-Blended Dual Crosslinker Results

| | Crosslinker | Crosslinker | |
|---|---|---|---|
| Sample | Solution | Amount (mL) | Viscosity (cP) |
| 4-1 | XLK1 | 0.35 | 1160 |
| 4-2 | XLK2 | 0.25 | 1425 |
| 4-3 | XLK4 | 0.245 | 356 |

A stock buffer solution was prepared by dissolving 25.2 g sodium bicarbonate and 11.4 g sodium hydroxide in 300 mL tap water. A 15.2 gpt solution of Flopam EM 430 was prepared by adding 7.6 mL of the liquid emulsion polymer to 500 mL tap water in a Black & Decker blender while mixing. The solution was mixed for approximately 10 minutes and was used in subsequent testing.

### Example 17

### Synthetic Polymer Dialdehyde Gel with Added Stabilizer

To four 120 g samples of polymer solution were added 2.4 mL of stock buffer to achieve a pH of about 11. Polymer solutions were then crosslinked by adding 0.2 mL 40 wt % glyoxal and stirring solution by hand with a spatula. Hydroquinone was added as a freshly made aqueous solution and stirred into the gel. Hydroquinone concentrations tested were 0, 500, 830 and 2000 ppm. The resulting gel was transferred into a 350 mL bomb reactor and heated in an oven at 120° C. for 30 minutes. After 30 minutes the samples were removed from the oven and allowed to cool to about 30° C. The viscosity of the cooled samples was measured using a Chandler 3500 viscometer with a R1B2F1 configuration operated at a speed of 300 rpm. Viscometer readings (lb/100 ft²) for the four samples were 6, 23, 22, and 9 respectively.

### Example 18

### Tunable Surfactant and Associative Polymer Gel

This example shows the effect that the tunable surfactant has on the viscosity of the associative polymer with temperature. Solution A was prepared as follows. A 0.24 wt % solution of Superpusher C319 from SNF (Andrezieux FRANCE) in tap water was prepared by adding 0.24 g of polymer to the water while stirring at a moderate rate. The mixture was allowed to blend for 10 minutes. Solution B was prepared as follows. A 0.1 g sample of Surfactant A (see note below for synthesis) was added to 100 g of tap water and stirred until it dissolved. Next 0.24 g of Superpusher C319 was added while stirring the solution at a moderate rate. The mixture was further stirred for another 10 minutes. Solution C was prepared in the same manner as Solution B but the surfactant used was Surfactant B (see note below). Viscosity measurements were taking using a Brookfield DV-III Rheometer at room temperature at after heating the sample at 80° C. for 1 hour (spindle #3, 30 rpm). The measured viscosity values are shown in Table 17.

TABLE 17
Viscosity Measurements

| Solution | Viscosity (cP) at 25° C. | Viscosity (cP) at 80° C. |
|---|---|---|
| A | 639 | 440 |
| B | 623 | 660 |
| C | 340 | 492 |

The data shows that for the solutions containing the tunable surfactant, the viscosity of the sample increases with increasing temperature. For the solution of polymer by itself, the viscosity decreases with temperature.

For synthesis of Surfactant A, a reactor was charged with Glycidyl hexadecyl ether (Aldrich) (5.97 g, 20 mmol), JEFFAMINE® ED-600 (XTJ-500) with MW=600 (HUNTSMAN, Austin, Tex. 78752, USA) (6 g, 10 mmol) and 25 ml of isopropanol. The mixture was stirred for 5 hours under reflux and under nitrogen. Then the solvent was stripped off under vacuum. The reaction was monitored by Fourier transform infrared spectrometry (FTIR) following the disappearance of the 915 cm⁻¹ peak (epoxy group) and the appearance of the broad peak at 3500 cm⁻¹ (hydroxy group) The peak at 915 cm⁻¹ disappeared almost completely with only very small traces left, indicating that the starting materials have reacted.

For synthesis of Surfactant B, see Example 8 in United States Patent Application Publication No. 2011/0309001, the contents of which are expressly incorporated by reference herein.

### Example 19

### Crosslinked Base Polymer

This example shows how the introduction of crosslinking during polymerization yields polymers that have different viscosity when dissolved in water. A typical polymerization recipe was prepared as follows:

A water-in-oil emulsion of acrylamide/acrylic acid/methylene bisacrylamide copolymer was prepared by mixing 130.78 g of acrylamide (50 wt % in water), 0.0176 g of methylene bisacrylamide, 7.37 g of acrylic acid, 29.91 g of DI-water and 0.03 g of ethylenediamine tetraacetic acid tetrasodium salt. Enough NaOH (50 percent aqueous) was added to the solution to raise the pH to approximately 7. In a separate container it was prepared the organic phase by mixing 62.5 g of Isopar M, 7.73 g of Span 80 and 3.53 g of Tween 85. The organic phase was then placed in a reactor equipped with a mechanical stirrer, a nitrogen sparger, condenser, a thermometer and a gas exit. Next, the aqueous phase was added to the reactor while stirring at 800 rpm. The mixture was purged with nitrogen at 1 L/min for 30 minutes. Next, 0.0125 g of Azobisisobutyronitrile was added to the reactor, the temperature increased to 55° C. and the nitrogen flow set at 0.4 L/min. The reaction was allowed to proceed for 2 hours. Next the temperature was increased to 70° C. and held for 1 hour. Once the reaction cooled down below 35° C., 2.5 g of thiosulfate dissolved in 3 g of water was added while stirring at 400 rpm for 15 minutes. Next 7.5 g of a polyethylene oxide lauryl alcohol surfactant, HLB-14.4, (ETHAL LA-12/80% from Ethox) was added to the above reaction product and the mixture mixed at 400 rpm for 15 minutes. The resulting product was a homogeneous emulsion.

Six separate reactions were done being the only difference the amount of crosslinker used. Water solutions of the synthesized polymers were prepared by dissolving 0.3 g of the emulsion polymers in tap water and vigorously mixing until they form homogeneous solutions. Next the viscosity of the solutions was measure using a Brookfield DV-III Rheometer (spindle #2, 30 rpm). The results are shown in Table 18.

TABLE 18
Viscosities of Base Polymer Solutions

| meq. MBA/total monomer* | Viscosity (cP) |
|---|---|
| 0 | 148 |
| 0.1 | 221 |
| 0.3 | 242 |
| 0.5 | 227 |
| 0.75 | 186 |
| 1 | 42 |

*Milliequivalents of methylene bisacrylamide per total mol monomer

The table shows how the viscosity of the solutions can be controlled by the amount of crosslinker introduced in the reactions. The viscosity of the solutions increases with concentration of crosslinker but they reach a maximum. Further increasing of the amount of crosslinker forms solutions with lower viscosity due to the formation of crosslinked particles.

### Example 20

### Blend of PAA Superabsorbent with Emulsion Polymer

Crosslinked superabsorbent polymer was blended with an uncrosslinked water soluble base polymer to generate a higher viscosity linear fluid. The total polymer concentration in the system was maintained at about 0.46 wt %. Lightly crosslinked polyacrylic acid (PAA) from Sigma-Aldrich was used as the superabsorbent polymer. SNF Flopam EM 430 was used as a water soluble base polymer. The two polymers were combined by adding both to about 500 mL of tap water in Black and Decker blender. The superabsorbent powder was added to the water first and given about 1 minute to begin swelling before adding the emulsion polymer. The two polymer system was then given about 10 minutes to fully swell/hydrate. After 10 minutes about 175 ml, of the polymer solution were loaded into a Chandler 3500 viscometer equipped with a R1B2F1 configuration and a viscosity measurement was recorded at a speed of 300 rpm (shear rate of about 110 sec⁻¹). Results are shown in Table 19.

TABLE 19
Polymer Blend Viscosities

| Sample | EM 430 (mL) | Crosslinked PAA (g) | Viscosity (cP) |
|---|---|---|---|
| A | 7.6 | 0 | 124 |
| B | 5.7 | 0.6 | 134 |
| C | 3.8 | 1.2 | 124 |

### Example 21

### Blend of Carbopol 980 with Emulsion Polymer

Carbopol 980 is a water soluble crosslinked polyacrylic acid. A solution of Flopam EM 430 was formulated by adding 7.6 mL EM 430 to 500 mL tap water in a Black and Decker blender and mixing for about 10 minutes to fully hydrate the polymer. A 0.48 wt % solution of Carbopol 980 in tap water was formulated by adding 2.41 g of Carbopol 980 to 500 mL tap water and mixing until Carbopol 980 is fully dispersed. Then about 2 mL of 1 M sodium hydroxide was used to adjust 200 mL of the Carbopol 980 solution to a pH of about 11. The pH adjusted Carbopol was then blended with a solution of EM 430 in tap water at different ratios. About 170 mL of the polymer blends was loaded into a Chandler 3500 viscometer at a speed of 300 rpm with a R1B2F1 configuration to measure the viscosity of the fluid at about 110 sec⁻¹. Results are shown in Table 21.

TABLE 21
Blended Polymer Solution Viscosities

| | EM 430 | Carbopol 980 | |
|---|---|---|---|
| Sample | Solution (wt %) | Solution (wt %) | Viscosity (cP) |
| 2-1 | 100 | 0 | 124 |
| 2-2 | 75 | 25 | 134 |
| 2-3 | 50 | 50 | 311 |

### Example 22

### Guar as Crosslink Extender

Progel 4.5 is a slurry of guar in diesel fluid at a concentration of 4.5 lb/gal. Flopam EM430 is an anionic polyacrylamide in a water-in-oil emulsion. Polymer solutions were formulated by dispersing the polymer concentrate in tap water while mixing in a Black and Decker blender and continuing to mix for approximately 8 minutes to fully hydrate the polymer. Guar solutions were prepared at 40 lbs/Mgal concentration by adding 4.4 mL Progel 4.5 to 500 mL tap water. EM430 solutions were prepared at about 40 lbs/Mgal active polymer by adding 7.5 mL EM430 to 500 mL tap water. Polymer solutions were then used in subsequent tests.

A stock buffer solution was prepared by dissolving 25.2 g sodium bicarbonate and 11.4 g sodium hydroxide in 300 mL tap water. Stock 1M sodium hydroxide was prepared by dissolving 4 g sodium hydroxide pellets in 100 g tap water.

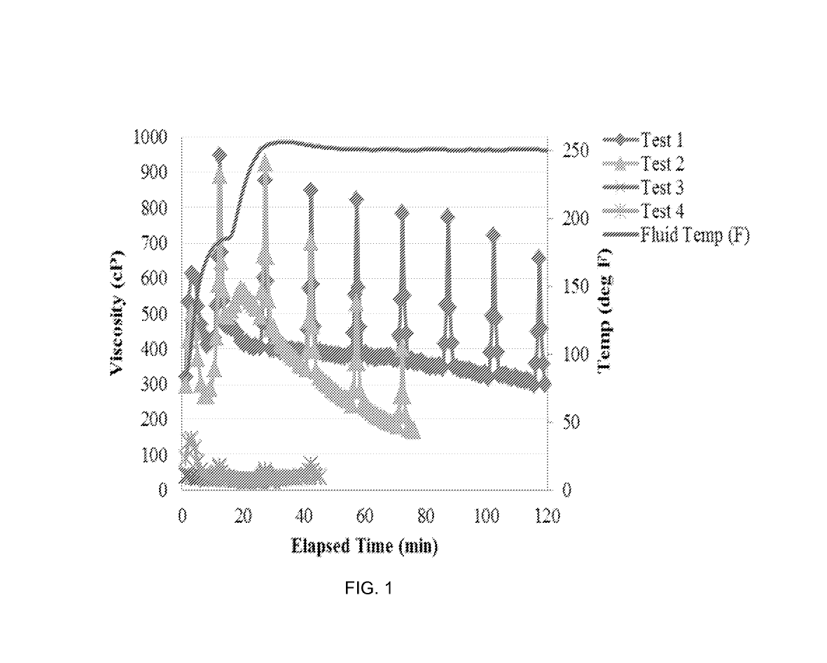

The results of Example 22, described as Tests #1-4 are shown in FIG. 1. In Test #1, 50 mL of the guar solution was added to 450 mL of EM430 solution and mixed in the blender for approximately 2 minutes to homogenize. The pH of the solution was then adjusted to about 11 by adding 7.5 mL of sodium bicarbonate/sodium hydroxide buffer and 0.75 mL 1M NaOH. After pH adjustment, 0.88 gpt 40 wt % glyoxal and 0.76 gpt Tyzor 217 (zirconium based crosslinker) were added. The crosslinkers were allowed to mix into the system for about 45 seconds before a 50 mL sample was pulled and loaded into a Grace M5600 HTHP viscometer with a B5 bob. The viscometer was run continuously at a shear rate of 100 sec⁻¹ with periodic shear ramps in which the shear rate changed in following order 100 sec⁻¹, 75 sec⁻¹, 50 sec⁻¹, 25 sec⁻¹, 50 sec⁻¹, 75 sec⁻¹, 100 sec⁻¹. The temperature increased from ambient temperature to 180° F. and then to 250° F. Test #2 is the same as Test #1 but with 0 mL guar solution and 500 mL EM430 solution. Test #3 is the same as Test #1 but with no glyoxal. Test #4 is the same as Test #1 but with no Tyzor 217.

Viscosity and temperature data for Tests #1-4 are plotted in FIG. 1.

### Example 23

### Blend of Emulsion Polymer with Guar Slurry

A blend of Progel 4.5 and Flopam EM430 was prepared by adding 30 g Flopam EM430 to a 50 mL centrifuge tube. To the Flopam EM430 was added 2 g Progel 4.5. The Progel 4.5 was stirred into the emulsion polymer with a spatula until the mixture was visually homogenous (about 1 minute). The blend was then used in subsequent viscosity tests.

### Example 24

### Performance of Emulsion Polymer Blended with Guar Slurry

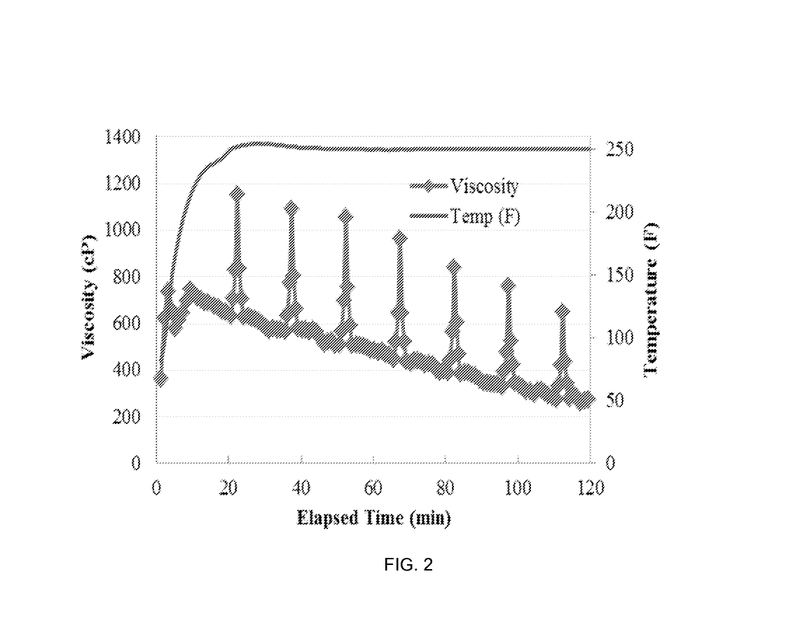

To 500 mL of tap water in an Osterizer blender was added 7.2 mL of a blend of Progel 4.5 and Flopam EM430 from the previous example. The polymer blend was give approximately 8 minutes to hydrate. After 8 minutes 7.5 mL sodium bicarbonate/sodium hydroxide buffer (prepared as described above) and 0.75 mL of 1M sodium hydroxide were added to the polymer solution to achieve a pH of about 11. After pH adjustment 0.88 gpt 40 wt % glyoxal and 0.76 gpt Tyzor 217 were added. The crosslinkers were allowed to mix into the system for about 45 seconds before a 50 mL sample was pulled and loaded into a Grace M5600 HTHP viscometer with a B5 bob. The viscometer was run continuously at a shear rate of 100 sec⁻¹ with periodic shear ramps in which the shear rate changed in following order 100 sec⁻¹, 75 sec⁻¹, 50 sec⁻¹, 25 sec⁻¹, 50 sec⁻¹, 75 sec⁻¹, 100 sec⁻¹ as described in API Recommended Practice 13M. The temperature increased from ambient temperature to 250° F. Viscosity and temperature are plotted in FIG. 2.

### Example 25

### No Hydration Time

A blend of Progel 4.5 and Flopam EM430 was prepared by adding 31.2 g Flopam EM430 to a 50 mL centrifuge tube. To the Flopam EM430 was added 1 g Progel 4.5. The Progel 4.5 was stirred into the emulsion polymer with a spatula until the mixture was visually homogenous (about 1 minute). The blend was then used in the following test. In this example the gel was formulated by first adding 7.5 mL of a sodium bicarbonate/sodium hydroxide buffer (prepared as described above) and 0.75 mL 1M sodium hydroxide to 500 mL tap water in an Osterizer blender and dissolving 10 lbs/Mgal sodium thiosulfate and 0.4 gpt Ethal LA-12/80 in the water. Then 6 mL of the blend of Progel 4.5 and Flopam EM430, 0.88 gpt 40 wt % glyoxal and 0.76 gpt Tyzor 217 were added to the blender simultaneously. The polymer concentrate was not hydrated before being combined with the buffer and crosslinkers. The polymer concentrate and crosslinkers were allowed to mix into the system for about 45 seconds before a 50 mL sample was pulled and loaded into a Grace M5600 HTHP viscometer with a B5 bob. The viscometer was run continuously at a shear rate of 100 sec⁻¹ with periodic shear ramps in which the shear rate changed in following order 100 sec⁻¹, 75 sec⁻¹, 50 sec⁻¹, 25 sec⁻¹, 50 sec⁻¹, 75 sec⁻¹, 100 sec⁻¹ as described in API Recommended Practice 13M. The temperature increased from ambient temperature to 250° F. Viscosity at a shear rate of 100 sec⁻¹ and temperature are recorded in Table 22 below.

TABLE 22
Viscosity Development of Fluid with no Hydration Time

| | Elapsed Time (min) | | | | | | | | |
|---|---|---|---|---|---|---|---|---|---|
| | 2 | 5 | 10 | 30 | 45 | 60 | 75 | 90 | 105 |
| Temperature (° F.) | 157 | 216 | 239 | 254 | 251 | 250 | 250 | 250 | 250 |
| Viscosity (cP) | 66 | 312 | 635 | 601 | 459 | 378 | 331 | 274 | 236 |

### Example 26

### Viscosity Enhancer

A blend of Progel 4.5 and Flopam EM430 was prepared by adding 31.2 g Flopam EM430 to a 50 mL centrifuge tube. To the Flopam EM430 was added 1 g Progel 4.5. The Progel 4.5 was stirred into the emulsion polymer with a spatula until the mixture was visually homogenous (about 1 minute). The blend was then used in the following test. To 500 mL Cambridge tap water in an Osterizer blender was added 6 mL of the blend of Progel 4.5 and Flopam EM430. The polymer blend was given approximately 8 minutes to hydrate. After 8 minutes, 7.5 mL sodium bicarbonate/sodium hydroxide buffer (prepared as described above) was added and the fluid pH was adjusted to 11 with 1M sodium hydroxide or 1M HCl as needed. After pH adjustment, 0.88 gpt 40 wt % glyoxal and 0.76 gpt Tyzor 217 were added. The crosslinkers were allowed to mix into the system for about 45 seconds before a 50 mL sample of the mixture was pulled and loaded into a Grace M5600 HTHP viscometer with a B5 bob. The viscometer was run continuously at a shear rate of 100 sec⁻¹ with periodic shear ramps in which the shear rate changed in following order 100 sec⁻¹, 75 sec⁻¹, 50 sec⁻¹, 25 sec⁻¹, 50 sec⁻¹, 75 sec⁻¹, 100 sec⁻¹ as described in API Recommended Practice 13M. The temperature increased from ambient temperature to 250° F. In tests where sodium aluminate was included, the sodium aluminate was added as a 38 wt % actives solution to the water in the blender directly before polymer hydration. Tests were repeated in tap water spiked with sodium silicate to model makeup water containing appreciable amounts of soluble silica. Sodium silicate was added to tap water to achieve a measurement of 50 mg/L of Molybdenum reactive silica. Soluble silica measurements were completed using a Hach DR-2700 spectrophotometer following Hach test method 656 Silica HR. Results in tap water spiked with silica are shown for 0, 0.4, and 1.8 gpt loadings of 38 wt % solution of sodium aluminate (SA). Viscosities at a shear rate of 100 sec⁻¹ are listed along with temperature values in Table 23 below.

TABLE 23
Viscosity Development of Fluids with Different
Levels of Sodium Aluminate

| | Elapsed Time (min) | | | | | | |
|---|---|---|---|---|---|---|---|
| | 5 | 10 | 15 | 30 | 40 | 50 | 60 |
| Temperature (° F.) | 163 | 220 | 240 | 255 | 252 | 251 | 250 |
| Viscosity 0 gpt SA | 189 | 168 | 165 | 146 | 141 | 135 | 129 |
| (cP) | | | | | | | |
| Viscosity, 0.4 gpt SA | 287 | 355 | 367 | 319 | 311 | 293 | 278 |
| (cP) | | | | | | | |
| Viscosity, 1.8 gpt SA | 365 | 412 | 364 | 357 | 375 | 341 | 340 |
| (cP) | | | | | | | |

### Example 27

### Improved Polymer Hydration Time

A 1% potassium chloride solution was prepared by dissolving 30 g potassium chloride in 3 L Cambridge tap water. The potassium chloride solution was then used as water source of polymer hydration tests. Polymer hydration tests were conducted by adding 5 mL Flopam EM430 to 500 mL fluid in Black and Decker blender. Polymer was added to the vortex and allowed 1 minute to disperse through the fluid. After 1 minute the blender was stopped and the polymer solution was loaded into an OFI Model 800 viscometer with a R1B1F1 configuration and run at 300 rpm. Viscosity was observed and recorded over the course of 15 minutes (see Table 24). In some tests a small amount of Ethal LA-12/80 was dissolved in the fluid prior to addition of polymer.

TABLE 24
Viscosity of Solutions Containing
Ethal LA-12/80 as a Hydration Aid

| Test | Ethal LA-12/80 | Viscosity Measurements at Different Times (cP) | | | |
|---|---|---|---|---|---|
| # | (gpt) | 1 min | 3 min | 5 min | 15 min |
| 1 | 0 | 2 | 2 | 3 | 3 |
| 2 | 0.2 | 6 | 7 | 7 | 10 |
| 3 | 0.4 | 14 | 16 | 16 | 16 |

### Example 28

### Breaking of Gel with Magnesium Peroxide

To 500 mL Cambridge tap water in an Osterizer blender was added 0.2 g magnesium peroxide (MgO₂) followed by 12 gpt of the blend of Flopam EM430. The polymer blend was given approximately 8 minutes to hydrate. After 8 minutes 7.5 mL sodium bicarbonate/sodium hydroxide buffer (prepared as described above) and 0.75 mL 1M sodium hydroxide solution were added to the blender. After pH adjustment 0.88 gpt 40 wt % glyoxal and 0.76 gpt Tyzor 217 were added. The crosslinkers were allowed to mix into the system for about 45 seconds before a 50 mL sample was pulled and loaded into a Grace M5600 HTHP viscometer with a B5 bob. The viscometer was run continuously at a shear rate of 100 sec⁻¹ with periodic shear ramps in which the shear rate changed in following order 100 sec⁻¹, 75 sec⁻¹, 50 sec⁻¹, 25 sec⁻¹, 50 sec⁻¹, 75 sec⁻¹, 100 sec⁻¹ as described in API Recommended Practice 13M. The temperature increased from ambient temperature to 250° F. within the first 20 minutes of the viscosity profile. Viscosities at a shear rate of 100 sec⁻¹ are listed in Table 25 below. Values from an identical viscosity profile with no magnesium peroxide are included for comparison.

TABLE 25
Viscosity Data Showing the Effect of MgO₂ Breaker

| | Elapsed Time (min) | | | | | | |
|---|---|---|---|---|---|---|---|
| | 5 | 10 | 15 | 30 | 40 | 50 | 60 |
| Temperature (° F.) | 212 | 241 | 245 | 253 | 251 | 250 | 250 |
| Viscosity w/ MgO₂ | 254 | 418 | 361 | 118 | 32 | 14 | 10 |
| (cP) | | | | | | | |
| Viscosity, no MgO₂ | 294 | 398 | 387 | 297 | 290 | 267 | 265 |
| (cP) | | | | | | | |

### EQUIVALENTS

While specific embodiments of the subject invention have been disclosed herein, the above specification is illustrative and not restrictive. While this invention has been particularly shown and described with references to preferred embodiments thereof, it will be understood by those skilled in the art that various changes in form and details may be made therein without departing from the scope of the invention encompassed by the appended claims. Many variations of the invention will become apparent to those of skilled art upon review of this specification. Unless otherwise indicated, all numbers expressing reaction conditions, quantities of ingredients, and so forth, as used in this specification and the claims are to be understood as being modified in all instances by the term “about.” Accordingly, unless indicated to the contrary, the numerical parameters set forth herein are approximations that can vary depending upon the desired properties sought to be obtained by the present invention.

While this invention has been particularly shown and described with references to preferred embodiments thereof, it will be understood by those skilled in the art that various changes in form and details may be made therein without departing from the scope of the invention encompassed by the appended claims.

What is claimed:

1. A polymer-enhanced proppant transport fluid, comprising:
a suspension fluid comprising a crosslinked synthetic polymer gel formulation, and
a plurality of proppant particles.

2. The fluid of claim 1, wherein the crosslinked synthetic polymer gel formulation comprises:
at least one synthetic base polymer, and
a crosslinking agent, wherein the crosslinking agent comprises a dialdehyde or a dual crosslinker system.

3. The fluid of claim 2, wherein the dual crosslinker system comprising a dialdehyde and an organometallic reagent.

4. The fluid of claim 2, wherein the crosslinked synthetic polymer gel formulation comprises a second base polymer.

5. The fluid of claim 4, wherein the second base polymer is a synthetic base polymer.

6. The fluid of claim 5, wherein the at least one synthetic base polymer and the second base polymer are crosslinked.

7. The fluid of claim 6, wherein the crosslinking is performed by a crosslinking agent.

8. The fluid of claim 1, wherein the crosslinked synthetic polymer gel formulation further comprises a hydrophobically associating base polymer with a tunable surfactant.

9. The fluid of claim 1, wherein the crosslinked synthetic polymer gel formulation further comprises a superabsorbent polymer with a water soluble polymer.

10. A method of improving production from an oil or gas well, comprising:
providing a formulation comprising a crosslinked synthetic polymer gel formulation, and
delivering the formulation into the oil or gas well, whereby the formulation improves production from the well.

11. A method of water blocking or water shutoff in an oil or gas well, comprising:
providing a formulation comprising a crosslinked synthetic polymer gel formulation, and
delivering the formulation into the oil or gas well, whereby the formulation provides water blocking or water shutoff in the well.

12. A method of enhancing oil recovery from an oil source, comprising:
providing a formulation comprising a crosslinked synthetic polymer gel formulation, and
delivering the formulation into the oil source, whereby the formulation enhances oil recover from the oil source.

13. A method of treating a petroleum-containing formation to reduce sand production, comprising:
providing a formulation comprising a crosslinked synthetic polymer gel formulation, and
delivering the formulation into the petroleum-containing formation, whereby the formulation reduces sand production in the formation.

14. A method of displacing fluid from a wellbore by viscous plug flow, comprising:
providing a formulation comprising a crosslinked synthetic polymer gel formulation, and
delivering the formulation into wellbore, whereby the formulation forms a viscous plug in the wellbore, thereby displacing fluid therefrom.
